(19) United States
(12) Patent Application Publication
(10) Pub. No.: US 2026/0163608 A1
(43) Pub. Date: Jun. 11, 2026

(54) DATA RECEPTION DEVICE AND DATA RECEPTION METHOD

(71) Applicant: Renesas Electronics Corporation, Tokyo (JP)

(72) Inventor: Wataru NAITO, Tokyo (JP)

(21) Appl. No.: 19/364,079

(22) Filed: Oct. 21, 2025

(30) Foreign Application Priority Data
Dec. 11, 2024 (JP) 2024-216276

(51) Int. Cl. H04B 7/005; H04B 7/08

(52) U.S. Cl. CPC H04B 7/005; H04B 7/084

(57) ABSTRACT

To achieve desired performance, a data reception device comprises receiving unit and an adaptive equalization processing unit. The receiving unit generates a received signal based on a first wireless signal received by a first antenna and a second wireless signal received by a second antenna. The adaptive equalization processing unit performs adaptive equalization processing to asymptotically match the received signal based on the first wireless signal and the second wireless signal generated by the receiving unit to a predetermined training signal.

### CROSS-REFERENCE TO RELATED APPLICATIONS

The disclosure of Japanese Patent Application No. 2024-216276 filed on Dec. 11, 2024, including the specification, drawings and abstract is incorporated herein by reference in its entirety.

### BACKGROUND

The present invention relates to a data reception device and a data reception method, which can be suitably used, for example, in a data reception device and a data reception method for receiving radio signals with a first antenna and a second antenna.

There are disclosed techniques listed below.
[Patent Document 1] Japanese Unexamined Patent Application Publication No. 2009-278525
[Patent Document 2] Japanese Unexamined Patent Application Publication No. 2011-124616

For example, as a technique for performing diversity reception using a first antenna and a second antenna, Patent Documents 1 and 2 are known. Patent Documents 1 and 2 describe switching the receiving antenna based on the reception quality of the radio signal.

### SUMMARY

However, in related technologies such as those in Patent Documents 1 and 2, it may be difficult to achieve the desired performance.

Other objects and novel features will become apparent from the description of this specification and the accompanying drawings.

According to one embodiment, a data reception device generates a received signal based on a first radio signal received by a first antenna and a second radio signal received by a second antenna. The data reception device performs adaptive equalization processing to make the generated received signal asymptotically approach a predetermined training signal.

According to the embodiment, the desired performance can be achieved.

### BRIEF DESCRIPTION OF THE DRAWINGS

FIG. 1 is a timing chart showing the operation during antenna switching in an Examined Example 1.

FIG. 2 is a configuration diagram showing the configuration of the analog front end in an Examined Example 2.

FIG. 3 is a configuration diagram showing an outline configuration of data reception device according to the embodiment.

FIG. 4 is a configuration diagram showing a configuration example of the data reception device according to the first embodiment.

FIG. 5 is a configuration diagram showing a configuration example of the adaptive equalization circuit according to the first embodiment.

FIG. 6 is a flowchart showing an operation example of the data reception device according to the first embodiment.

FIG. 7 is a configuration diagram showing a configuration example of the data reception device according to the second embodiment.

FIG. 8 is a configuration diagram showing a configuration example of the adaptive equalization circuit according to the second embodiment.

FIG. 9 is a flowchart showing an operation example of the data reception device according to the second embodiment.

FIG. 10 is a graph showing a specific example of signals for explaining the operation example of the data reception device according to the second embodiment.

FIG. 11 is a configuration diagram showing a configuration example of the data reception device according to the third embodiment.

FIG. 12 is a flowchart showing an operation example of the data reception device according to the third embodiment.

### DETAILED DESCRIPTION

Below, the embodiments will be described with reference to the drawings. For clarity of explanation, the following description and drawings are appropriately omitted and simplified. In addition, in each drawing, the same elements are denoted by the same reference numerals, and repetitive descriptions are omitted as necessary.

### Examined Examples

First, Examined Examples 1 and 2, which were considered by the inventors, will be described.

Similar to Patent Documents 1 and 2, the Examined Example 1 is an example of performing diverse reception by switching between two antennas. In the Examined Example 1, the antenna receiving from two antennas is switched by a switch circuit. Furthermore, the consistency (correlation) between the received signal and a predetermined training signal (also called a preamble signal) is detected to determine the antenna to be used.

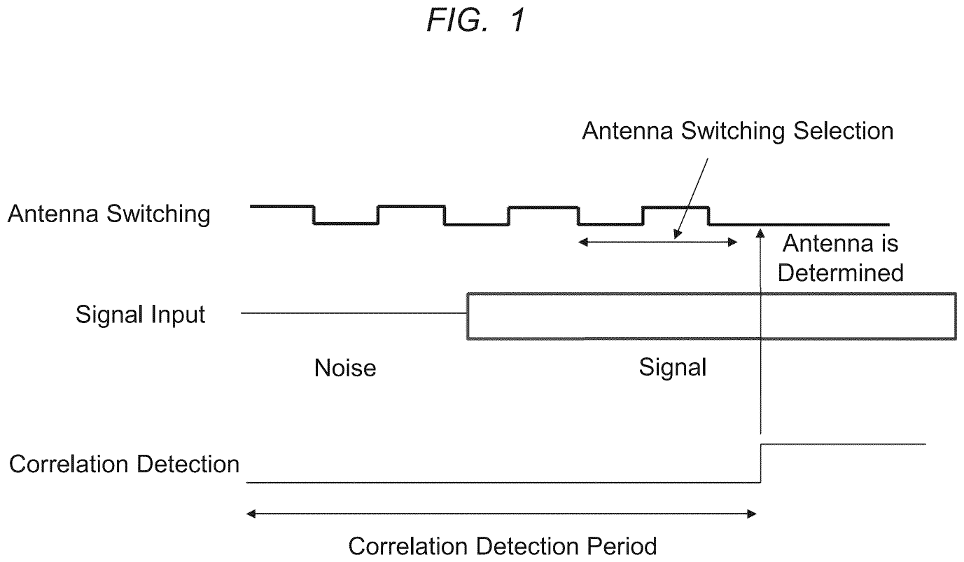

FIG. 1 shows the operation during antenna switching in the Examined Example 1. As shown in FIG. 1, in the Examined Example 1, during the correlation detection period, the antenna receiving the signal (training signal) is switched to monitor both antenna levels, and the antenna to be used is determined based on the detected correlation value.

In the Examined Example 1, at least three times of antenna switching time (three monitoring times) are required to determine the antenna to be used. First, the first antenna is selected, and the correlation between the signal received by the first antenna and the training signal is detected. Next, the antenna is switched to the second antenna, and the correlation between the signal received by the second antenna and the training signal is detected. At this time, there is a possibility that the reception quality of the first antenna is fluctuating. Therefore, the antenna is switched back to the first antenna, and the correlation between the signal received by the first antenna and the training signal is detected again, and finally, the antenna with the higher correlation is selected.

Therefore, in the Examined Example 1, it takes time to determine the optimal antenna. Also, in the Examined Example 1, when the signal-to-noise ratio (SN ratio) deteriorates, the signal is buried in noise, so it is necessary to continue adding for a long time to cancel the noise, and it takes time for correlation detection. Note that when noise is added for one cycle, it is offset, and the signal becomes larger, improving the SN ratio.

The Examined Example 2 is an example of performing diversity reception using the MRC method. In the MRC method, after phase adjustment so that the phase of the signals received by the two antennas becomes the same, the two signals are combined to maximize the SN ratio.

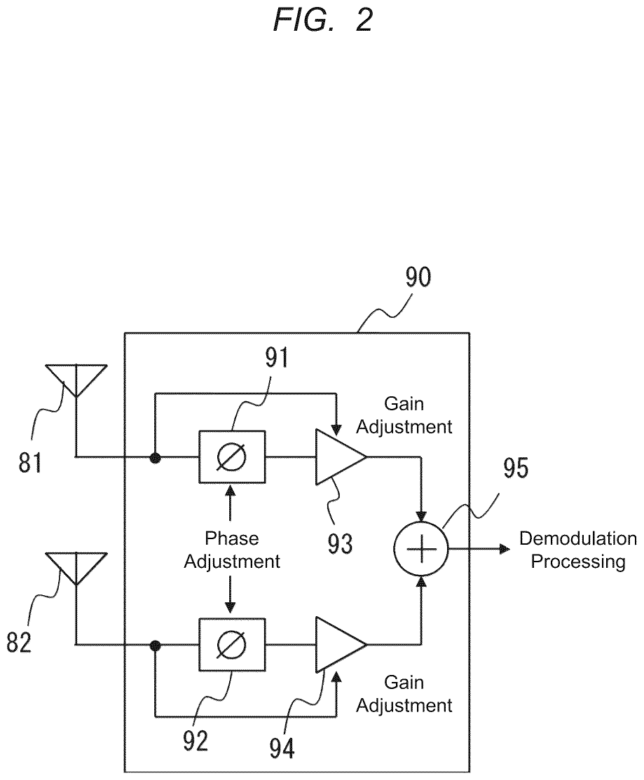

FIG. 2 shows the configuration of the analog front end in the Examined Example 2. As shown in FIG. 2, the analog front end 90 of the Examined Example 2 includes phase shifters 91 and 92, variable gain amplifiers 93 and 94, and a combined 95 to perform combining using the MRC method. The combiner 95 combines the signal received by antenna 81 and the signal received by antenna 82. Specifically, it combines the signal whose phase and gain are adjusted by phase shifter 91 and variable gain amplifier 93, and the signal whose phase and gain are adjusted by phase shifter 92 and variable gain amplifier 94.

In the Examined Example 2, since the signals received by the two antennas are mixed in the analog front end, a switch for switching antennas is unnecessary. However, in the Examined Example 2, although antenna switching time becomes unnecessary compared to the Examined Example 1, if the phase is not matched, reception cannot be performed, so RF circuits for phase adjustment and gain adjustment are required for two paths, increasing the circuit size.

Thus, in the Examined Example 1, the antenna with a better SN ratio is selected by correlation detection using antenna switching. In the Examined Example 1, at least three times of antenna switching time is required, and there is a problem that detection time becomes too long when the SN ratio deteriorates. For example, in Wi-Sun standards and other standards, the time from the start of signal reception to determining the antenna and enabling demodulation (training period) is specified, but in the Examined Example 1, it is difficult to achieve performance that meets the standards, and if the processing time to determine the antenna to meet Wi-Sun standards and other standards is shortened, performance degradation such as deterioration in reception sensitivity and incorrect antenna selection occurs due to reduced detection accuracy.

Also, in the Examined Example 2, signals are mixed in the analog front end using the MRC method. In the Examined Example 2, a switch for switching antennas becomes unnecessary, and processing time is faster, but there is a problem that RF circuits for phase adjustment and gain adjustment are required for two paths, increasing the circuit size.

Therefore, in the embodiment, without performing antenna switching, the MRC method is combined with digital-side adaptive equalization processing to synthesize signals from two antennas. This eliminates the antenna selection time that was taken three times in the Examined Example 1, shortening the processing time (to about ⅓). Furthermore, by performing adaptive equalization processing on the digital side, it becomes possible to perform diversity reception without adding circuits to the analog front end.

### Outline of the Embodiment

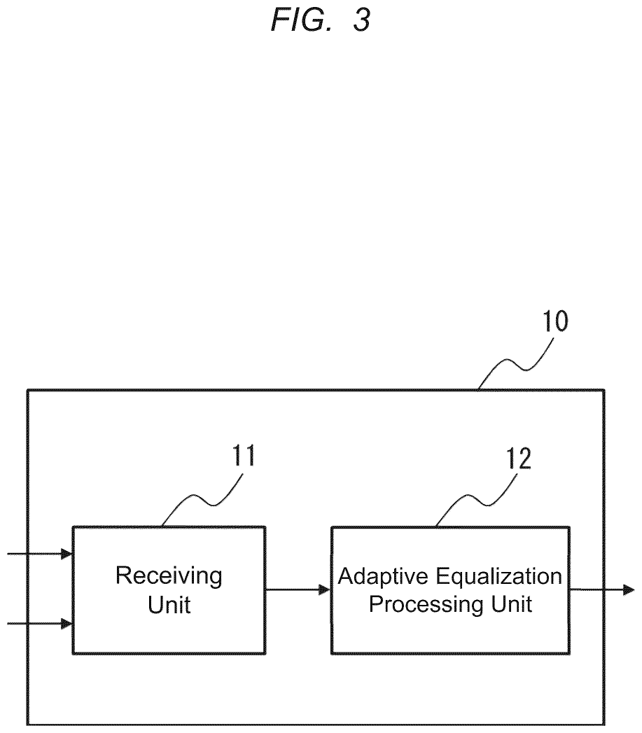

FIG. 3 shows an outline configuration of a data reception device 10 according to the embodiment. The data reception device 10 receives wireless signals in a wireless communication system. The data reception device 10, together with a transmitting device that transmits wireless signals, constitutes a wireless communication system. The data reception device 10 mainly has a function of receiving wireless signals, but it may also be a communication device with the function of transmitting wireless signals. The data reception device 10 may receive wireless signals of any wireless communication standard. For example, the wireless communication standard may be Wi-Sun, wireless LAN, Bluetooth (registered trademark), mobile communication standards such as 4G and 5G, or other standards. In wireless communication standards, when the transmitting device starts transmitting data, it is stipulated to first transmit a predetermined training signal for a predetermined period (training period) and then transmit a signal containing data. The data reception device 10 receives wireless signals including training signals.

As shown in FIG. 3, the data reception device 10 includes a receiving unit 11 and an adaptive equalization processing unit 12. For example, the receiving unit 11 and the adaptive equalization processing unit 12 may be configured by one or any number of semiconductor devices. For example, the receiving unit 11 may be configured with analog circuits, and the adaptive equalization processing unit 12 may be configured with digital circuits, or both the receiving unit 11 and the adaptive equalization processing unit 12 may be configured with digital circuits.

The data reception device 10 performs diversity reception using, for example, a first antenna and a second antenna. The receiving unit 11 generates a reception signal based on the first wireless signal received by the first antenna and the second wireless signal received by the second antenna. For example, receiving unit 11 may include a synthesizing unit that synthesizes the first wireless signal and the second wireless signal and generates the synthesized reception signal.

Also, the receiving unit 11 may include a first receiving unit that generates a first reception signal based on the first wireless signal and a second receiving unit that generates a second reception signal based on the second wireless signal.

The adaptive equalization processing unit 12 performs adaptive equalization processing to asymptotically approach the reception signal generated by the receiving unit 11 to a predetermined training signal. When the receiving unit 11 synthesizes the first wireless signal and the second wireless signal, the adaptive equalization processing unit 12 may perform adaptive equalization processing on the synthesized reception signal. For example, the adaptive equalization processing unit 12 may include a phase difference calculation unit that calculates the phase difference between the reception signal after adaptive equalization processing and the predetermined training signal. In this case, the receiving unit 11 may include a phase adjustment unit that adjusts the phase difference between the first wireless signal and the second wireless signal based on the calculated phase difference.

As described above, there are cases where the receiving unit 11 generates a first reception signal based on the first wireless signal and a second reception signal based on the second wireless signal. In this case, the adaptive equalization processing unit 12 may include a first adaptive equalization processing unit and a second adaptive equalization processing unit. The first adaptive equalization processing unit performs the first adaptive equalization processing to asymptotically approach the generated first reception signal to a predetermined training signal. The second adaptive equalization processing unit performs second adaptive equalization processing to asymptotically approach the generated second reception signal to a predetermined training signal. For example, the adaptive equalization processing unit 12 may include a synthesizing unit that synthesizes the first reception signal after first adaptive equalization processing and the second reception signal after second adaptive equalization processing. The adaptive equalization processing unit 12 may include a phase adjustment unit that adjusts the phase difference between the first reception signal after first adaptive equalization processing and the second reception signal after second adaptive equalization processing.

Thus, in the embodiment, adaptive equalization processing is performed on signals based on wireless signals received by two antennas in a data reception device that performs diversity reception, asymptotically approaching the training signal. This eliminates the need for antenna switching, allowing for reduced processing time. Therefore, necessary processing can be performed within the training period specified by the standard, achieving the desired performance. Additionally, by performing adaptive equalization processing, implementation with digital circuits becomes possible, suppressing the increase in circuit size.

### First Embodiment

Next, a first embodiment will be described. In this embodiment, an example of synthesizing signals from two antennas in the analog front end and performing adaptive equalization processing on the synthesized signal will be described.

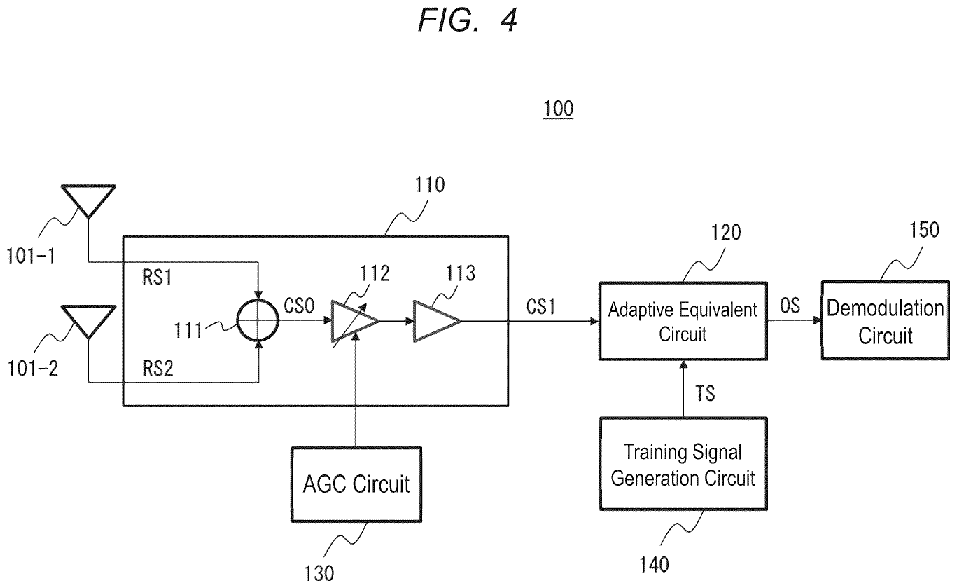

FIG. 4 shows a configuration example of a data reception device 100 according to the first embodiment. In FIG. 4, the data reception device 100 is equipped with antennas 101-1 and 101-2, an analog front-end 110, an adaptive equivalent circuit 120, an AGC circuit 130, a training signal generation circuit 140, and a demodulation circuit 150. Furthermore, the data reception device 100 is not limited to two antennas and may be equipped with any number of antennas, two or more. That is, adaptive equivalent processing may be performed on signals received by two or more antennas.

For example, the analog front-end 110 is composed of analog circuits. The adaptive equivalent circuit 120, the AGC circuit 130, the training signal generation circuit 140, and the demodulation circuit 150 are composed of digital circuits. Each part of the data reception device 100 may be implemented by a semiconductor device. The analog front-end 110 may be included in a semiconductor device that implements analog circuits. The adaptive equivalent circuit 120, the AGC circuit 130, the training signal generation circuit 140, and the demodulation circuit 150 may be included in a semiconductor device that implements digital signal processing circuits. For instance, the semiconductor device may be a semiconductor package containing a first semiconductor chip and a second semiconductor chip. The first semiconductor chip may include the analog front-end 110. The second semiconductor chip may include the adaptive equivalent circuit 120, the AGC circuit 130, the training signal generation circuit 140, and the demodulation circuit 150.

The antenna 101-1 (first antenna) and the antenna 101-2 (second antenna) each receive radio waves. The antennas 101-1 and 101-2 generate RF signals RS1 (first radio signal) and RS2 (second radio signal) in response to the received radio waves.

The analog front-end 110 is a receiving circuit (receiving unit) that receives signals via the antennas 101-1 and 101-2. The analog front-end 110 synthesizes RF signals RS1 and RS2 received by the antennas 101-1 and 101-2 and generates a composite signal CS1 of digital signals. In the example of FIG. 4, the analog front-end 110 includes a combiner 111, a variable gain amplifier 112, and an ADC (Analog Digital Converter) 113.

The combiner 111 is a synthesis circuit (synthesis unit) that synthesizes RF signal RS1 received by antenna 101-1 and RF signal RS2 received by antenna 101-2, generating a composite signal CS0 of analog signals.

The variable gain amplifier 112 is a gain adjustment circuit (gain adjustment unit) that adjusts the gain (amplitude) of the composite signal CS0 synthesized by the combiner 111. The variable gain amplifier 112 adjusts the amplitude of the composite signal CS0 within the input range of the ADC 113 according to control from the AGC circuit 130. If the amplitude of the composite signal CS0 is within the input range of the ADC 113, the gain adjustment by the variable gain amplifier 112 may be omitted.

The ADC 113 performs AD conversion on the composite signal CS0 after gain adjustment by the variable gain amplifier 112, generating a composite signal CS1 of digital signals.

The adaptive equivalent circuit 120 performs adaptive equivalent processing on the composite signal CS1 generated by the analog front-end 110, generating an output signal OS after adaptive equivalent processing. The adaptive equivalent circuit 120 uses the training signal TS from the training signal generation circuit 140 as a reference, asymptotically bringing the composite signal CS1 closer to the training signal TS and generating the asymptotic output signal OS. The adaptive equivalent circuit 120 estimates the transmission path by adaptive equivalent processing based on the same training signal TS as the transmitting device, adjusting the amplitude and phase of the composite signal CS1 containing signals from each antenna. Methods such as LMS (Least Mean Square) or Kalman may be used for adaptive equivalent processing.

The AGC (Automatic Gain Control) circuit 130 automatically controls the gain of the variable gain amplifier 112. For example, the AGC circuit 130 monitors the composite signal CS0 synthesized by the combiner 111 and controls the gain of the variable gain amplifier 112 so that the amplitude of the composite signal CS0 falls within the input range of the ADC 113.

The training signal generation circuit 140 generates a predetermined training signal TS. The training signal TS is the same signal transmitted by the transmitting device and is a signal with a predetermined pattern specified by communication standards.

The demodulation circuit 150 performs demodulation processing on the output signal OS after adaptive equivalent processing by the adaptive equivalent circuit 120. The demodulation circuit 150 performs demodulation processing according to the modulation method of the transmitting device, generating received data. For example, the demodulation circuit 150 demodulates signals according to standards such as Wi-Sun or wireless LAN.

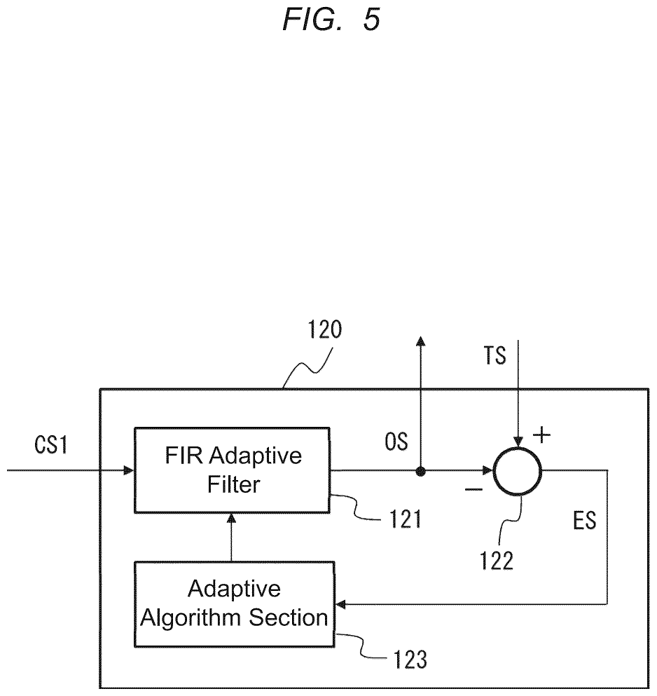

FIG. 5 shows a configuration example of the adaptive equivalent circuit 120 in the present embodiment. The adaptive equivalent circuit 120 estimates the transmission path from the difference between the input signal and the reference signal, determining the optimal filter through feedback for each frequency. In the example of FIG. 5, the adaptive equivalent circuit 120 includes an FIR (Finite Impulse Response) adaptive filter 121, an error calculation unit 122, and an adaptive algorithm unit 123.

The FIR adaptive filter 121 filters the composite signal CS1 with filter characteristics according to control from the adaptive algorithm unit 123. The FIR adaptive filter 121 outputs the filtered output signal OS.

The error calculation unit 122 calculates the difference between the output signal OS from the FIR adaptive filter 121 and the training signal TS, outputting an error signal ES indicating the calculated difference (error). For example, the error signal ES includes the phase difference and amplitude difference between the two signals.

The adaptive algorithm unit 123 controls the filter characteristics of the FIR adaptive filter 121 based on the error signal ES from the error calculation unit 122 according to a predetermined adaptive algorithm (LMS, Kalman, etc.). The adaptive algorithm unit 123 adjusts the tap coefficients of the FIR adaptive filter 121 so that the error between the output signal OS and the training signal TS is minimized. By repeatedly performing feedback control on the FIR adaptive filter 121 by the adaptive algorithm unit 123, the output signal OS asymptotically converges to the training signal TS. For example, the output signal OS after adaptive equivalent processing is a signal that has asymptotically converged to the training signal TS.

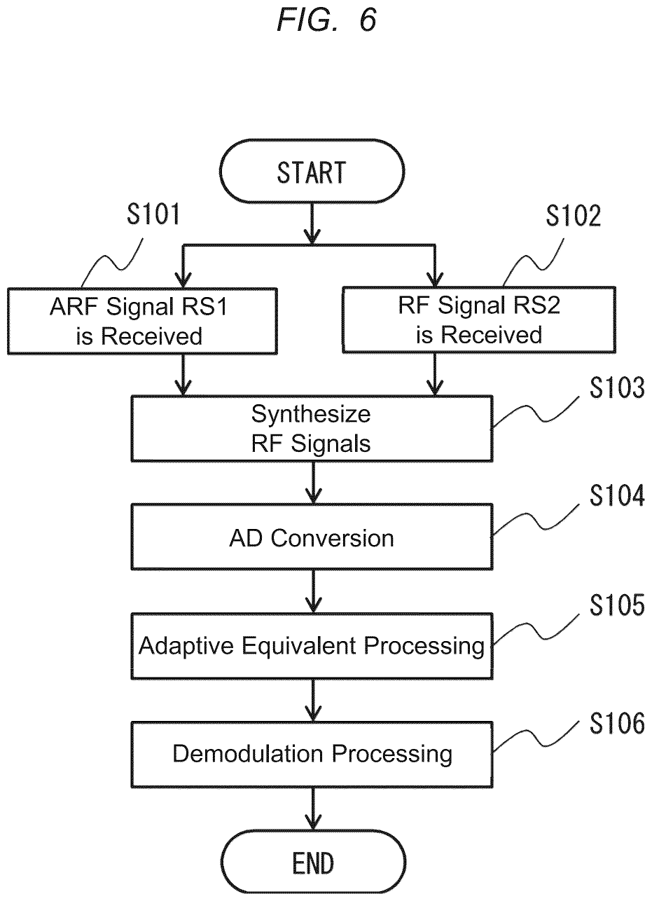

FIG. 6 shows an example of the operation of the data reception device 100 according to the present embodiment. In the example of FIG. 6, RF signal RS1 is received by antenna 101-1 (S101), and RF signal RS2 is received by antenna 101-2 (S102).

Subsequently, the combiner 111 synthesizes RF signal RS1 received by antenna 101-1 and RF signal RS2 received by antenna 101-2 (S103). The variable gain amplifier 112 adjusts the gain of the composite signal CS0 synthesized by the combiner 111 according to control from the AGC circuit 130. Subsequently, the ADC 113 performs AD conversion on the composite signal CS0 after gain adjustment by the variable gain amplifier 112 (S104).

Subsequently, the adaptive equivalent circuit 120 performs adaptive equivalent processing on the composite signal CS1 of digital signals AD converted by the ADC 113 (S105). The adaptive equivalent circuit 120 uses the training signal TS from the training signal generation circuit 140 as a reference, asymptotically bringing the composite signal CS1 closer to the training signal TS and generating the output signal OS. Specifically, the adaptive algorithm unit 123 adjusts the characteristics of the FIR adaptive filter 121 so that the error between the output signal OS and the training signal TS becomes smaller.

Subsequently, the demodulation circuit 150 performs demodulation processing on the output signal OS after adaptive equivalent processing by the adaptive equivalent circuit 120 (S106).

As described above, in the present embodiment, signals from two antennas are synthesized in the analog front-end, and adaptive equivalent processing is performed on the synthesized signal. In the present embodiment, only asymptotic processing by adaptive equivalent is performed against the antenna switching method of the Examined Example 1, so issues such as wrong selection of antenna or processing time do not occur. In the present embodiment, since the time for antenna switching is unnecessary, the processing time can be reduced to about one-third compared to the Examined Example 1.

In the MRC method of the Examined Example 2, the phase and amplitude of RF signals from two antennas were adjusted and mixed by analog circuits. In the present embodiment, compared to the Examined Example 2, using the adaptive equivalent circuit of digital circuits can prevent an increase in circuit area.

### Second Embodiment

As described above, in the first embodiment, the signals from two antennas are combined in the analog front end, and adaptive equalization processing is performed on the combined signal. In this case, if the phase of the signals between the antennas shifts by 180 degrees, it may not be possible to properly adjust the phase difference, potentially reducing the S/N ratio. Therefore, in the present embodiment, the configuration of the data reception device in the first embodiment is modified to detect the phase difference with an adaptive equalization circuit and adjust the phase difference of the signals between the antennas.

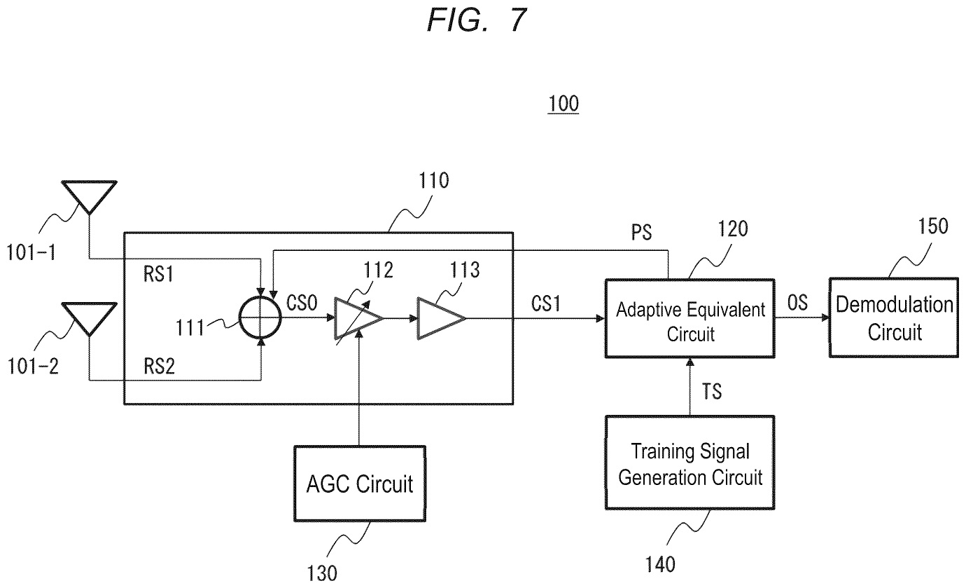

FIG. 7 shows a configuration example of a data reception device 100 according to the present embodiment. In the example of FIG. 7, the data reception device 100 has a configuration similar to that of FIG. 4. That is, the data reception device 100 includes antennas 101-1 and 101-2, an analog front end 110, an adaptive equalization circuit 120, an AGC circuit 130, a training signal generation circuit 140, and a demodulation circuit 150. Here, the configuration different from FIG. 4 will be mainly described.

In the present embodiment, the adaptive equalization circuit 120 outputs phase deviation information PS, which indicates the phase difference between the output signal OS after adaptive equalization processing and the training signal TS, to the combiner 111 of the analog front end 110.

The combiner 111 adjusts the phase difference between the RF signal RS1 received by the antenna 101-1 and the RF signal RS2 received by the antenna 101-2 based on the phase deviation information PS from the adaptive equalization circuit 120. For example, the combiner 111 includes a phase adjustment circuit (phase adjustment unit) that adjusts the phase difference. The phase adjustment circuit may be a phase shifter, for example. The phase adjustment circuit may be disposed between the antennas 101-1 and 101-2 and the combiner 111. The combiner 111 combines the RF signals RS1 and RS2, whose phases have been adjusted based on the phase deviation information PS.

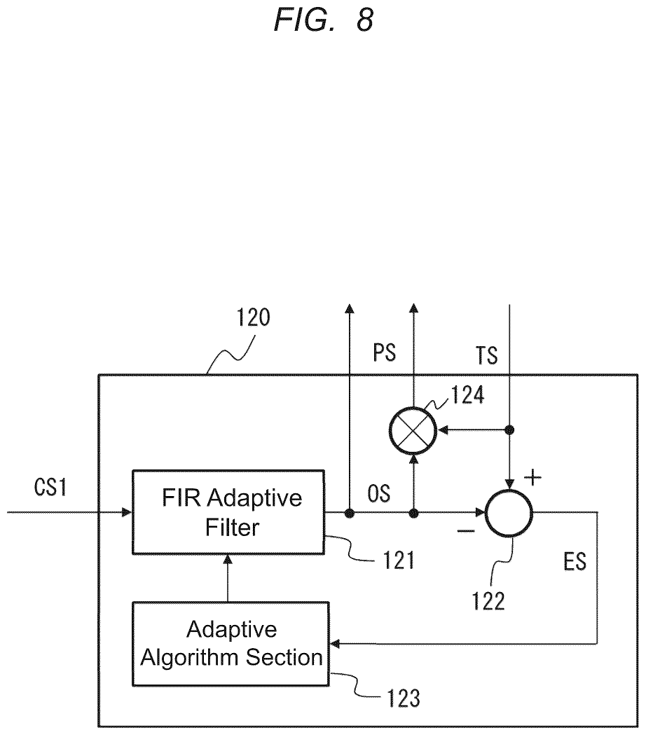

FIG. 8 shows a configuration example of the adaptive equalization circuit 120 according to the present embodiment. In the example of FIG. 8, the adaptive equalization circuit 120 includes, similar to FIG. 5, an FIR adaptive filter 121, an error calculation unit 122, an adaptive algorithm unit 123, and further includes a phase difference calculation unit 124.

The phase difference calculation unit 124 calculates the phase difference between the output signal OS after adaptive equalization processing output from the FIR adaptive filter 121 and the training signal TS. The phase difference can be obtained by multiplying the output signal OS and the training signal TS. The phase difference calculation unit 124 outputs the phase deviation information PS, based on the calculated phase difference, to the combiner 111.

In the present embodiment, to determine the phase difference between the two antennas, the phase difference is calculated twice:
once in the direction where the difference calculated by the error calculation unit 122 is maximized and once in the direction where it is minimized. The difference between the two-phase differences becomes the phase difference of the signals between the antennas. Specifically, the phase difference calculation unit 124 calculates the first phase difference between the output signal OS and the training signal TS when the error calculated by the error calculation unit 122 is asymptotically (converging) maximized. The phase difference calculation unit 124 calculates the second phase difference between the output signal OS and the training signal TS when the error calculated by the error calculation unit 122 is asymptotically (converging) minimized. Furthermore, the phase difference calculation unit 124 calculates the difference between the first phase difference when the error is maximized and the second phase difference when the error is minimized, and outputs the phase deviation information PS indicating the calculated difference.

For example, suppose the phase difference of the signal from the antenna 101-1 is −10 degrees, and the phase difference of the signal from the antenna 101-2 is +15 degrees. In this case, shifting the phase of the antenna 101-2 by −15 degrees will make the phases of the antenna 101-1 and the antenna 101-2 the same. Therefore, −15 degrees is fed back to the analog front end 110 as the phase deviation information PS.

The basic operation of the data reception device 100 according to the present embodiment is the same as in FIG. 6 of the first embodiment. In the present embodiment, phase deviation information is fed back from the adaptive equalization processing (S105) for the synthesis of RF signals (S103) in FIG. 6.

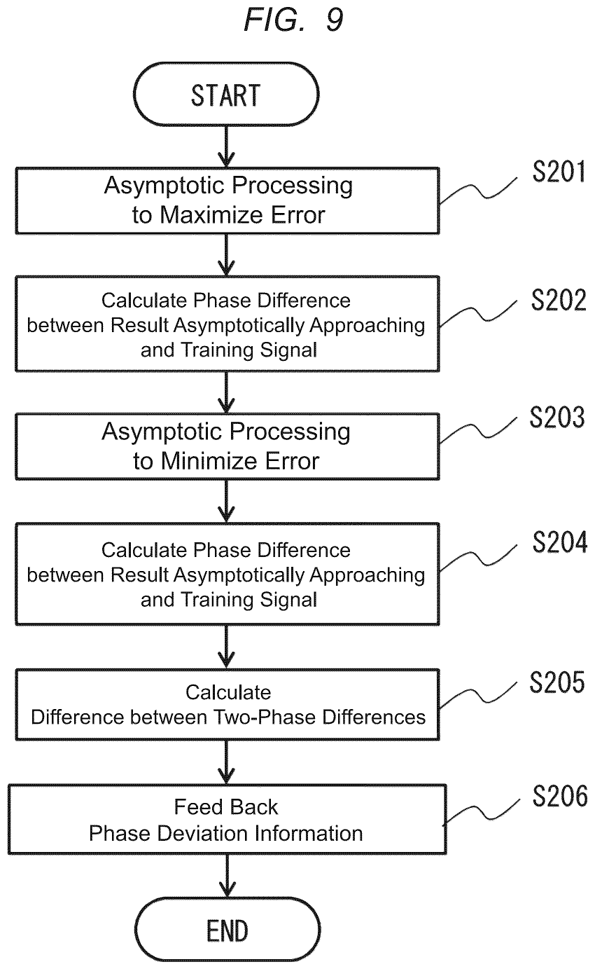

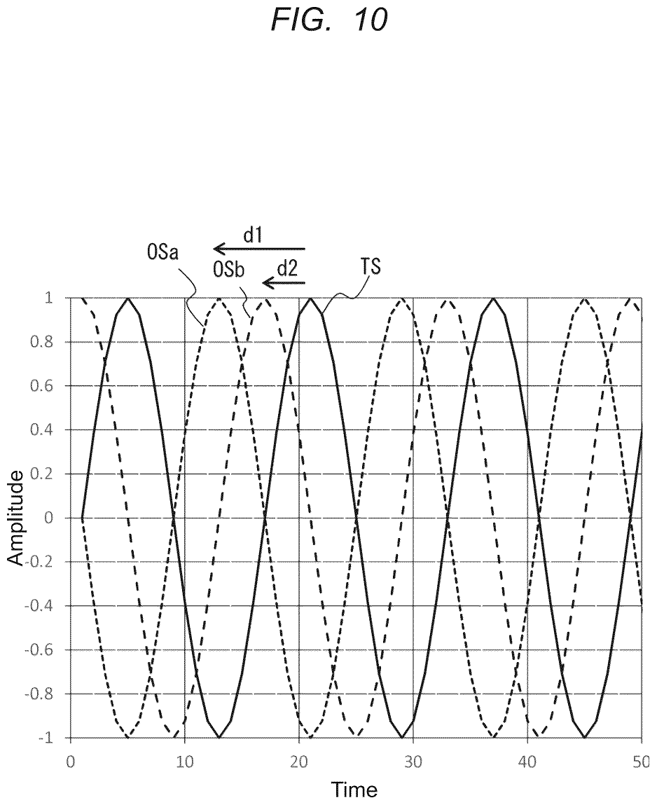

The operation of calculating the phase difference with the adaptive equalization circuit 120 and feeding back the phase deviation information will be described with reference to FIGS. 9 and 10. Note that in FIG. 9, S203 and S204 may be performed before S201 and S202.

As shown in FIG. 9, the adaptive equalization circuit 120 performs asymptotic processing (adaptive equalization processing) to maximize the error (S201). For example, the phase difference calculation unit 124 may switch the operation (asymptotic direction) of the adaptive algorithm unit 123 to calculate the phase difference between the two antennas. The adaptive algorithm unit 123 performs adaptive equalization processing that asymptotically approaches in the opposite direction to the first embodiment. Specifically, the characteristics of the FIR adaptive filter 121 are adjusted so that the error (error signal ES) between the output signal OS and the training signal TS passing through the FIR adaptive filter 121 is maximized.

Subsequently, the adaptive equalization circuit 120 calculates the phase difference between the asymptotic result with the maximum error (result asymptotically approaching the higher S/N ratio) and the training signal (S202). The phase difference calculation unit 124 calculates the phase difference between the output signal OS and the training signal TS when the error between them is asymptotically (converging) maximized. For example, in the example of FIG. 10, the phase difference d1 (first phase difference) between the output signal OSa asymptotically maximized for error and the training signal TS is calculated.

Subsequently, the adaptive equalization circuit 120 performs asymptotic processing to minimize the error (S203). The adaptive algorithm unit 123 performs adaptive equalization processing that asymptotically approaches in the same direction as the first embodiment. Specifically, the characteristics of the FIR adaptive filter 121 are adjusted so that the error (error signal ES) between the output signal OS and the training signal TS passing through the FIR adaptive filter 121 is minimized.

Subsequently, the adaptive equalization circuit 120 calculates the phase difference between the asymptotic result with the minimum error (result asymptotically approaching the lower S/N ratio) and the training signal (S204). The phase difference calculation unit 124 calculates the phase difference between the output signal OS and the training signal TS when the error between them is asymptotically (converging) minimized. For example, in the example of FIG. 10, the phase difference d2 (second phase difference) between the output signal OSb asymptotically minimized for error and the training signal TS is calculated.

Subsequently, the adaptive equalization circuit 120 calculates the difference between the two-phase differences (S205). The phase difference calculation unit 124 calculates the difference between the phase difference when the error is maximized, calculated in S202, and the phase difference when the error is minimized, calculated in S204, as the phase difference between the two antennas. In the example of FIG. 10, the difference between the phase difference d1 between the output signal OSa and the training signal TS and the phase difference d2 between the output signal OSb and the training signal TS is obtained.

Subsequently, the adaptive equalization circuit 120 feeds back the difference between the two-phase differences as phase deviation information PS to the analog front end 110 (S206). The combiner 111 adjusts the phase difference between the RF signal RS1 received by the antenna 101-1 and the RF signal RS2 received by the antenna 101-2 based on the fed-back phase deviation information PS. The combiner 111 may adjust the phase of either the RF signal RS1 or the RF signal RS2. For example, the phase of the RF signal with the lower S/N ratio (signal OSa in FIG. 10) may be adjusted to match the phase of the RF signal with the higher S/N ratio (signal OSb in FIG. 10). The combiner 111 shifts the phase of either the RF signal RS1 or the RF signal RS2 based on the phase deviation information PS and combines the shifted RF signals RS1 and RS2.

As described above, in the present embodiment, the phase difference is detected with the adaptive equalization circuit and fed back to the analog front end to adjust the phase difference of the signals between the antennas. This prevents the S/N ratio from decreasing when the phase of the signals between the antennas is shifted by 180 degrees. Since the optimal antenna signal and the phase difference between the antennas can be determined with the adaptive equalization circuit, feedback can be provided to adjust the phase to the optimal antenna signal. By aligning the phase of the signal from the antenna with the lower S/N ratio to the phase of the signal from the antenna with the higher S/N ratio, the S/N ratio can be improved.

### Third Embodiment

Next, the third embodiment will be described. In the present embodiment, an example will be described in which adaptive equalization processing is performed on each of the received signals from two antennas, and the phase difference of the signals after adaptive equalization processing is corrected and mixed.

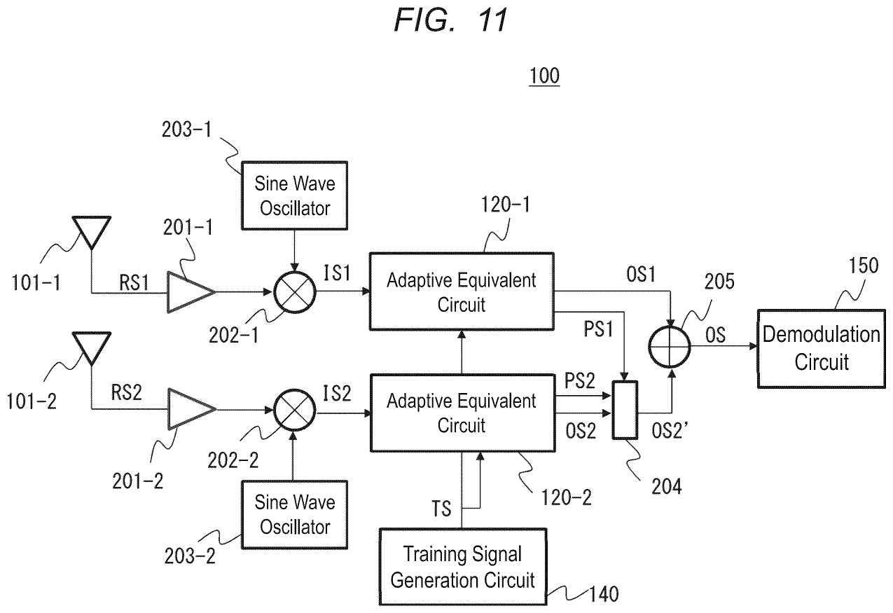

FIG. 11 shows a configuration example of the data reception device 100 according to the present embodiment. In the example of FIG. 11, the data reception device 100 includes antennas 101-1 and 101-2, ADCs 201-1 and 201-2, DCOs (Digitally Controlled Oscillators) 202-1 and 202-2, and sine wave oscillators 203-1 and 203-2. Furthermore, the data reception device 100 includes adaptive equalization circuits 120-1 and 120-2, a training signal generation circuit 140, a delay circuit 204, a combiner 205, and a demodulation circuit 150.

For example, configurations other than the antennas 101-1 and 101-2 are implemented by digital circuits. The digital circuits include the DCOs 202-1 and 202-2, and the sine wave oscillators 203-1 and 203-2. Furthermore, the digital circuits include adaptive equalization circuits 120-1 and 120-2, a training signal generation circuit 140, a delay circuit 204, a combiner 205, and a demodulation circuit 150.

The antenna 101-1 (first antenna) and antenna 101-2 (second antenna) receive radio waves, respectively, as in FIG. 4. “The antennas 101-1 and 101-2 generate high-frequency RF signals RS1 (first radio signal) and RS2 (second radio signal) in response to the received radio waves”.

For example, the ADC 201-1 and the DCO 202-1 constitute the first receiving circuit (first receiving unit) that receives the RF signal RS1 from antenna 101-1. The ADC 201-2 and the DCO 202-2 constitute the second receiving circuit (second receiving unit) that receives the RF signal RS2 from antenna 101-2.

The ADC 201-1 (first AD converter) and the ADC 201-2 (second AD converter) respectively perform AD conversion on the RF signals RS1 and RS2 received by the antennas 101-1 and 101-2. The ADC 201-1 and the ADC 201-2 generate RF signals RS1 and RS2 as digital signals after AD conversion. In this example, since the RF signal is directly AD converted, a gain adjustment circuit like in the first embodiment is unnecessary.

The DCO 202-1 (first frequency converter) and the DCO 202-2 (second frequency converter) receive the digital signals of RF signals RS1 and RS2. Additionally, sine waves generated by the sine wave oscillators 203-1 and 203-2 are input to the DCOs 202-1 and 202-2. Based on the sine waves generated by the sine wave oscillators 203-1 and 203-2, the DCOs 202-1 and 202-2 respectively generate IF signals IS1 and IS2 with frequencies corresponding to RF signals RS1 and RS2. The IF signals IS1 and IS2 are digital sine wave signals of intermediate frequency. The DCOs 202-1 and 202-2 are frequency converters (frequency conversion units) that convert high-frequency RF signals RS1 and RS2 into intermediate frequency IF signals IS1 and IS2.

The adaptive equivalent circuit 120-1 (first adaptive equivalent processing unit) performs adaptive equivalent processing (first adaptive equivalent processing) on IS1 generated by the DCO 202-1 based on training signal TS, similar to FIGS. 4 and 5. The adaptive equivalent circuit 120-1 generates output signal OS1 after adaptive equivalent processing. Similarly, the adaptive equivalent circuit 120-2 (second adaptive equivalent processing unit) performs adaptive equivalent processing (second adaptive equivalent processing) on IS2 generated by the DCO 202-2 based on training signal TS. The adaptive equivalent circuit 120-2 generates output signal OS2 after adaptive equivalent processing. Furthermore, the adaptive equivalent circuit 120-1 includes a phase difference calculation unit 124 (first phase difference calculation unit) that calculates the phase difference between output signal OS1 after adaptive equivalent processing and training signal TS, similar to FIG. 8. The adaptive equivalent circuit 120-1 outputs phase shift information PS1 based on the calculated phase difference to delay circuit 204. Similarly, the adaptive equivalent circuit 120-2 includes a phase difference calculation unit 124 (second phase difference calculation unit) that calculates the phase difference between output signal OS2 after adaptive equivalent processing and training signal TS. The adaptive equivalent circuit 120-2 outputs phase shift information PS2 based on the calculated phase difference to the delay circuit 204.

The delay circuit 204 delays the output signal OS2 generated by the adaptive equivalent circuit 120-2 based on the difference between phase shift information PS1 from the adaptive equivalent circuit 120-1 and phase shift information PS2 from the adaptive equivalent circuit 120-1. The phase shift information PS1 indicates the phase difference between output signal OS1 and training signal TS. The phase shift information PS2 indicates the phase difference between output signal OS2 and training signal TS. The delay circuit 204 generates the delayed output signal OS2′. The delay circuit 204 is a phase adjustment circuit (phase adjustment unit) that adjusts the phase difference between output signals OS1 and OS2 by adjusting the delay amount of output signal OS2. Note that the delay circuit 204 may also delay the output signal OS1 generated by the adaptive equivalent circuit 120-1.

The combiner 205 synthesizes the output signal OS1 after adaptive equivalent processing from the adaptive equivalent circuit 120-1 and the phase-adjusted output signal OS2′ from the delay circuit 204, and outputs the synthesized signal as output signal OS. Note that the training signal generation circuit 140 and demodulation circuit 150 are similar to those in FIG. 4.

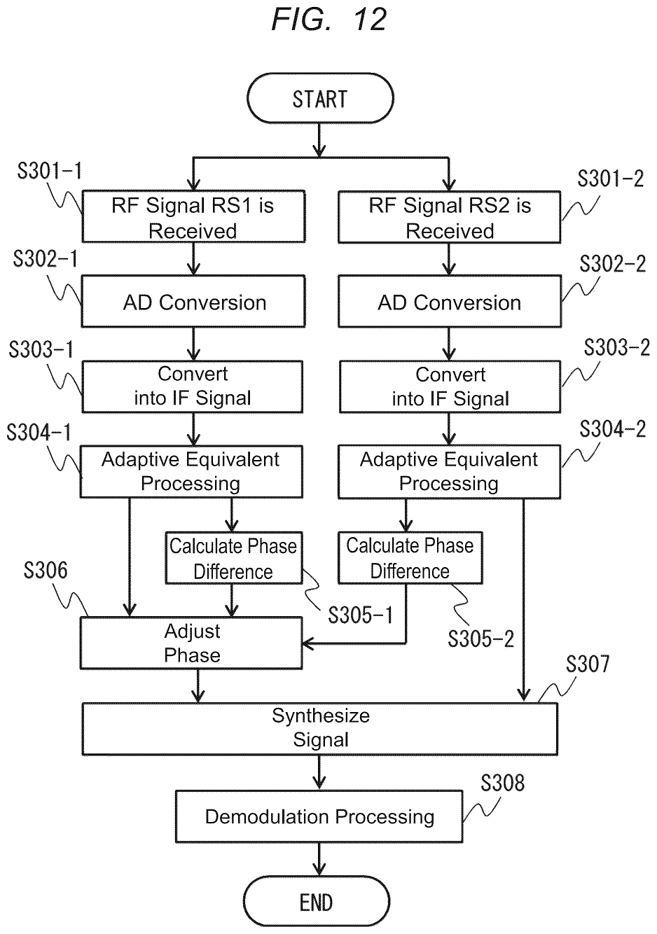

FIG. 12 shows an example of the operation of the data reception device 100 according to the present embodiment. In FIG. 12, the processing of the received signal from the antenna 101-1 (from S301-1 to S305-1) and the processing of the received signal from antenna 101-2 (from S301-2 to S305-2) are performed simultaneously in parallel.

In the processing of the received signal from antenna 101-1 from S301-1 to S305-1, first, RF signal RS1 is received by antenna 101-1 (S301-1). Subsequently, the ADC 201-1 performs AD conversion on the RF signal RS1 received by antenna 101-1 and generates the digital signal of RF signal RS1 (S302-1). Subsequently, the DCO 202-1 converts the digital signal of RF signal RS1 AD converted by ADC 201-1 into intermediate frequency IF signal IS1 (S303-1).

Subsequently, the adaptive equivalent circuit 120-1 performs adaptive equivalent processing on IF signal IS1 converted by the DCO 202-1 based on training signal TS from the training signal generation circuit 140 (S304-1). The adaptive equivalent circuit 120-1 performs adaptive equivalent processing so that the error between training signal TS and output signal OS1 is minimized, similar to the first embodiment. The adaptive equivalent circuit 120-1 outputs the output signal OS1 after adaptive equivalent processing. Subsequently, the adaptive equivalent circuit 120-1 calculates the phase difference (phase shift information PS1) between output signal OS1 after adaptive equivalent processing and training signal TS (S305-1).

Similarly, in the processing of the received signal from the antenna 101-2 from S301-2 to S305-2, RF signal RS2 is received by antenna 101-2 (S301-2). Subsequently, the ADC 201-2 performs AD conversion on the RF signal RS2 received by the antenna 101-2 and generates the digital signal of RF signal RS2 (S302-2). Subsequently, the DCO 202-2 converts the digital signal of RF signal RS2 AD converted by the ADC 201-2 into intermediate frequency IF signal IS2 (S303-2).

Subsequently, the adaptive equivalent circuit 120-2 performs adaptive equivalent processing on IF signal IS2 converted by the DCO 202-2 based on training signal TS from the training signal generation circuit 140 (S304-2). The adaptive equivalent circuit 120-2 performs adaptive equivalent processing so that the error between training signal TS and output signal OS2 is minimized, similar to the first embodiment. The adaptive equivalent circuit 120-2 outputs the output signal OS2 after adaptive equivalent processing. Subsequently, the adaptive equivalent circuit 120-2 calculates the phase difference (phase shift information PS2) between output signal OS2 after adaptive equivalent processing and training signal TS (S305-2).

Subsequently, the delay circuit 204 adjusts the phase of output signal OS2 based on the difference between the phase difference indicated by phase shift information PS1 and the phase difference indicated by phase shift information PS2 (S306). The phase shift information PS1 indicates the phase difference between output signal OS1 after adaptive equivalent processing by adaptive equivalent circuit 120-1 and training signal TS. The phase shift information PS2 indicates the phase difference between output signal OS2 after adaptive equivalent processing by the adaptive equivalent circuit 120-2 and the training signal TS. The delay circuit 204 calculates the difference between phase shift information PS1 and phase shift information PS2, and based on the calculated difference, delays output signal OS2 to adjust the phase, and outputs the phase-adjusted output signal OS2′.

Subsequently, the combiner 205 synthesizes the output signal OS1 after adaptive equivalent processing from the adaptive equivalent circuit 120-1 and the phase-adjusted output signal OS2′ from the delay circuit 204 (S307). The combiner 205 outputs the synthesized signal as output signal OS. Subsequently, the demodulation circuit 150 performs demodulation processing on output signal OS (S308).

As described above, in the present embodiment, adaptive equivalent processing is performed on each of the received signals from the two antennas. Since the phase difference between each antenna's received signal and the training signal can be calculated during each adaptive equivalent processing, the phase difference between the two antennas can be corrected, and the phases can be aligned and mixed. In this case, antenna switching is unnecessary, preventing issues such as wrong selection of antenna and processing time problems.

Furthermore, in the present embodiment, since each circuit of the data reception device can be configured with digital circuits, the increase in circuit area can be prevented. For example, by directly AD converting the RF signal, the RF circuit VCO (Voltage Controlled Oscillator) can be replaced with the digital oscillator DCO, thereby reducing the circuit area.

Note that each element described and depicted in the drawings as functional blocks performing various processes can be configured in hardware with a CPU (Central Processing Unit), memory, and other circuits. Additionally, in software, they can be implemented by programs loaded into memory. Therefore, it is understood by those skilled in the art that these functional blocks can be realized in various forms by hardware alone, software alone, or a combination thereof, and the present invention is not limited to any of them.

The above programs can be stored and provided to a computer using various types of non-transitory computer readable media. Non-transitory computer readable media includes various types of tangible storage media. Examples of non-transitory computer-readable media include magnetic recording media (e.g., flexible disks, magnetic tapes, hard disk drives) and magneto-optical recording media (e.g., magneto-optical disks). Examples of non-transitory computer-readable media also include CD-ROM (Read Only Memory), CD-R, and CD-R/W. Further examples of non-transitory computer-readable media include semiconductor memory (e.g., masked ROM, PROM (Programmable ROM)). Additional examples include EPROM (Erasable PROM), flash ROM, and RAM (Random Access Memory). Moreover, programs may also be supplied to the computer by various types of transitory computer-readable media. Examples of transitory computer-readable media include electrical signals, optical signals, and electromagnetic waves. The transitory computer-readable medium may provide the program to the computer via wired or wireless communication paths, such as electrical wires and optical fibers.

The invention made by the inventor has been specifically described based on the embodiment. However, the present invention is not limited to the embodiment already described, and it is needless to say that various modifications can be made without departing from the gist thereof.

What is claimed is:

1. A data reception device comprising:
a receiving unit that generates a received signal based on a first wireless signal received by a first antenna and a second wireless signal received by a second antenna; and
an adaptive equalization processing unit that performs adaptive equalization processing to asymptotically match the received signal to a predetermined training signal.

2. The data reception according to claim 1,
wherein the adaptive equalization processing unit includes: an FIR (Finite Impulse Response) filter that filters the received signal; a calculation unit that calculates the difference between the filtered received signal and the predetermined training signal; and an adaptive algorithm unit that controls the filter characteristics of the FIR filter based on the calculated difference according to an adaptive algorithm.

3. The data reception device according to claim 1,
wherein the receiving unit includes a combining unit that combines the first wireless signal and the second wireless signal to generate the received signal.

4. The data reception device according to claim 3,
wherein the receiving unit includes a phase adjustment unit that adjusts the phase difference between the first wireless signal and the second wireless signal before combining.

5. The data reception device according to claim 4,
wherein the combining unit includes the phase adjustment unit.

6. The data reception device according to claim 4,
wherein the adaptive equalization processing unit includes a phase difference calculation unit that calculates the phase difference between the received signal after adaptive equalization processing and the predetermined training signal, and the phase adjustment unit adjusts the phase difference between the first wireless signal and the second wireless signal based on the calculated phase difference.

7. The data reception device according to claim 6,
wherein the phase difference calculation unit calculates the difference between a first phase difference when the received signal after adaptive equalization processing is asymptotically matched to maximize the difference with the predetermined training signal, and a second phase difference when the received signal after adaptive equalization processing is asymptotically matched to minimize the difference with the predetermined training signal, and the phase adjustment unit adjusts the phase difference between the first wireless signal and the second wireless signal based on the calculated difference between the first phase difference and the second phase difference.

8. The data reception device according to claim 1, further comprising an analog front-end circuit including the receiving unit and a digital circuit including the adaptive equalization processing unit.

9. The data reception device according to claim 8,
wherein the analog front-end circuit includes a combining circuit that combines the first wireless signal and the second wireless signal, a gain adjustment circuit that adjusts the gain of the combined signal, and an AD (Analog-Digital) converter that converts the gain-adjusted signal to generate the received signal.

10. The data reception device according to claim 1,
wherein the receiving unit includes a first receiving unit that generates a first received signal based on the first wireless signal and a second receiving unit that generates a second received signal based on the second wireless signal, and the adaptive equalization processing unit includes a first adaptive equalization processing unit that performs first adaptive equalization processing to asymptotically match the first received signal to the predetermined training signal, and a second adaptive equalization processing unit that performs second adaptive equalization processing to asymptotically match the second received signal to the predetermined training signal.

11. The data reception device according to claim 10 further comprising a combining unit that combines the first received signal after the first adaptive equalization processing and the second received signal after the second adaptive equalization processing.

12. The data reception device according to claim 11 further comprising a phase adjustment unit that adjusts the phase difference between the first received signal after the first adaptive equalization processing and the second received signal after the second adaptive equalization processing.

13. The data reception device according to claim 12,
wherein the first adaptive equalization processing unit includes a first phase difference calculation unit that calculates a first phase difference between the first received signal after the first adaptive equalization processing and the predetermined training signal, and the second adaptive equalization processing unit includes a second phase difference calculation unit that calculates a second phase difference between the second received signal after the second adaptive equalization processing and the predetermined training signal, and the phase adjustment unit adjusts the phase difference between the first received signal after the first adaptive equalization processing and the second received signal after the second adaptive equalization processing based on the calculated first phase difference and the calculated second phase difference.

14. A data reception method comprising:
generating a received signal based on a first wireless signal received by a first antenna and a second wireless signal received by a second antenna; and
performing adaptive equalization processing to asymptotically match the received signal to a predetermined training signal.
